(19) United States
(12) Patent Application Publication
(10) Pub. No.: US 2013/0025690 A1
(43) Pub. Date: Jan. 31, 2013

(54) No-Contact Wet Processing Tool with Liquid Barrier

(71) Applicant: Glen Egami, San Jose, CA (US)

(72) Inventor: Glen Egami, San Jose, CA (US)

(73) Assignee: INTERMOLECULAR, INC., San Jose, CA (US)

(21) Appl. No.: 13/194,439

(22) Filed: Jul. 29, 2011

(51) Int. Cl. B01D 47/00

(52) U.S. Cl. 137/1; 137/565.17

(57) ABSTRACT

Embodiments of the present invention describe substrate processing tools and methods. A substrate on a support has a first portion and a second portion surrounding the first portion. An isolation unit including a body is positioned above the first portion of the substrate. The body includes at least one outlet on a lower surface thereof. At least one liquid pump is in fluid communication with the array of outlets. The at least one outlet is configured to drive liquid through the at least one outlet onto the substrate to form a liquid barrier around the first portion of the substrate.

### FIELD OF THE INVENTION

The present invention relates to apparatus and method for performing wet processing on a substrate. More particularly, this invention relates to a wet processing tool having site isolation, which does not contact the surface of the substrate to be processed.

### BACKGROUND OF THE INVENTION

Combinatorial processing enables rapid evaluation of semiconductor, solar, or energy processing operations. The systems supporting the combinatorial processing are flexible to accommodate the demands for running the different processes either in parallel, serial or some combination of the two.

Some exemplary processing operations include operations for adding (depositions) and removing layers (etch), defining features, preparing layers (e.g., cleans), doping, etc. Similar processing techniques apply to the manufacture of integrated circuit (IC) semiconductor devices, flat panel displays, optoelectronics devices, data storage devices, magneto electronic devices, magneto optic devices, packaged devices, and the like. As feature sizes continue to shrink, improvements, whether in materials, unit processes, or process sequences, are continually being sought for the deposition processes. However, semiconductor and solar companies conduct research and development (R&D) on full wafer processing through the use of split lots, as the conventional deposition systems are designed to support this processing scheme. This approach has resulted in ever escalating R&D costs and the inability to conduct extensive experimentation in a timely and cost effective manner. Combinatorial processing as applied to semiconductor, solar, or energy manufacturing operations enables multiple experiments to be performed at one time in a high throughput manner. Equipment for performing the combinatorial processing and characterization must support the efficiency offered through the combinatorial processing operations.

### BRIEF DESCRIPTION OF THE DRAWINGS

Various embodiments of the invention are disclosed in the following detailed description and the accompanying drawings:

FIG. 1 is a simplified cross-sectional schematic view of a substrate processing tool, according to one embodiment of the present invention;

FIG. 2 is a perspective view of a processing chamber within the substrate processing tool in FIG. 1;

FIG. 3 is a cross-sectional side view of an isolation unit body and a portion of a substrate within the substrate processing tool in FIG. 1;

FIG. 4 is a plan view of the isolation unit body along line 4-4 in FIG. 3;

FIG. 5 is a simplified cross-sectional schematic view of a substrate processing tool, according to another embodiment of the present invention

FIG. 6 is a cross-sectional side view of an isolation unit body and a portion of a substrate within the substrate processing tool in FIG. 7;

FIG. 7 is a plan view of the isolation unit body along line 7-7 in FIG. 6; and

FIG. 8 is a cross-sectional side view of an isolation unit body and a portion of the substrate within the substrate processing tool in FIG. 7, according to a another embodiment of the present invention.

### DETAILED DESCRIPTION

A detailed description of one or more embodiments is provided below along with accompanying figures. The detailed description is provided in connection with such embodiments, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For the purpose of clarity, technical material that is known in the technical fields related to the embodiments has not been described in detail to avoid unnecessarily obscuring the description.

Generally, the invention provides a substrate processing tool that allows portions of the upper surface of the substrate to be isolated from fluids (e.g., liquids) on the other portions of the upper surface of the substrate, without contacting the upper surface of the substrate. The isolation is accomplished using, for example, a combination of liquid barriers as seals and vacuum removal.

At each location to be isolated, a reactor (or isolation unit) is placed in close proximity with the upper surface of the substrate. The reactor has an outlet (or array of outlets) that is sized and shaped similar to a periphery of the location on the substrate to be isolated. Barrier fluid (i.e. a liquid) is driven through (either out of or in to) the the outlet, which causes the liquid barrier to be formed around the respective location. The liquid barrier prevents fluid on the substrate from flowing between the respective location and the remainder of the substrate. The liquid barrier may be used to contain a processing fluid on the particular location or prevent fluid on the remainder of the substrate from flowing onto the particular location.

The system may include one liquid pump for delivering the liquid onto the substrate and second liquid pump for removing the liquid from the substrate. In one example in which the liquid barrier is “stationary,” the outlet is a single annular trench connected to both pumps. In another example in which the liquid barrier undergoes a “constant flow,” there are two annular trench outlets, each connected to one of the pumps.

The system may also include a subsystem for controlling the temperature, and thus the surface tension, of the liquid within the liquid barrier. In one example, this subsystem flows a temperature-controlled fluid through a portion of the reactor such that heat is exchanged between the temperature-controlled fluid (and/or the reactor) and the liquid within the liquid barrier. Further, additional outlets and pumps may be provided to form a gas barrier in combination with the liquid barrier.

According to one aspect of the present invention, a substrate processing tool is provided. The substrate processing tool includes a housing defining a chamber. A substrate support is coupled to the housing and configured to support a substrate within the chamber. The substrate has an upper surface with a first portion and a second portion surrounding the first portion. An isolation unit including a body is coupled to the housing and positioned within the chamber above and spaced apart from the first portion of the upper surface of the substrate. The body includes at least one outlet on a lower surface thereof. At least one liquid pump is in fluid communication with the array of outlets. The at least one outlet is configured such that when liquid is delivered through the at least one outlet onto the upper surface of the substrate by the at least one liquid pump, a liquid barrier is formed around the first portion of the upper surface of the substrate. The liquid barrier prevents processing fluid on the upper surface of the substrate from flowing between the first portion of the upper surface of the substrate and the second portion of the upper surface of the substrate.

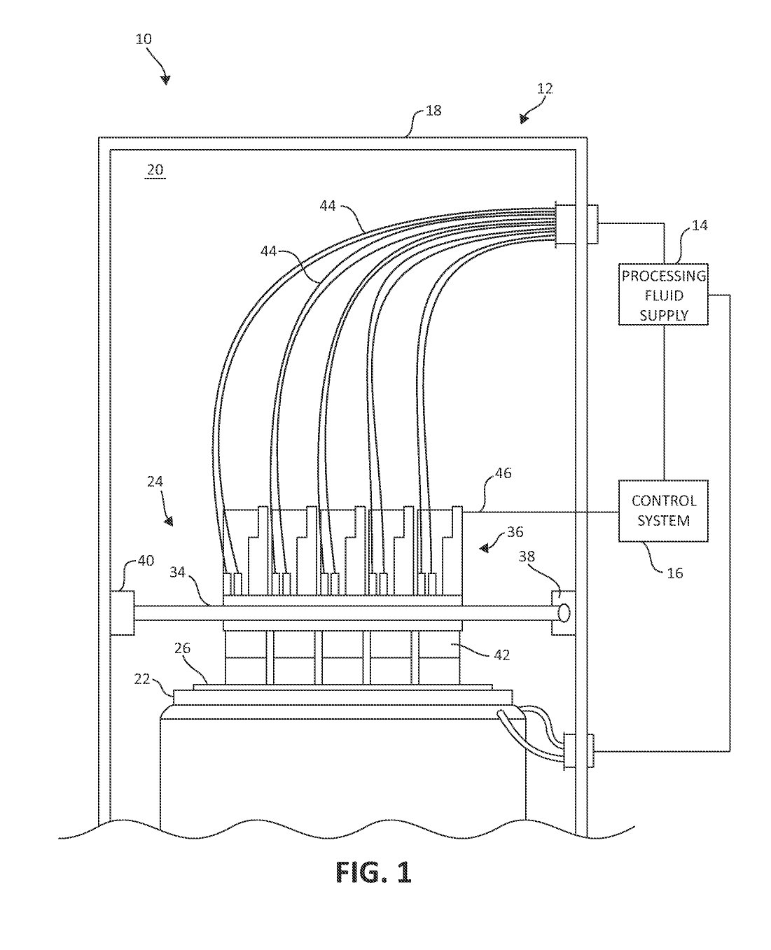

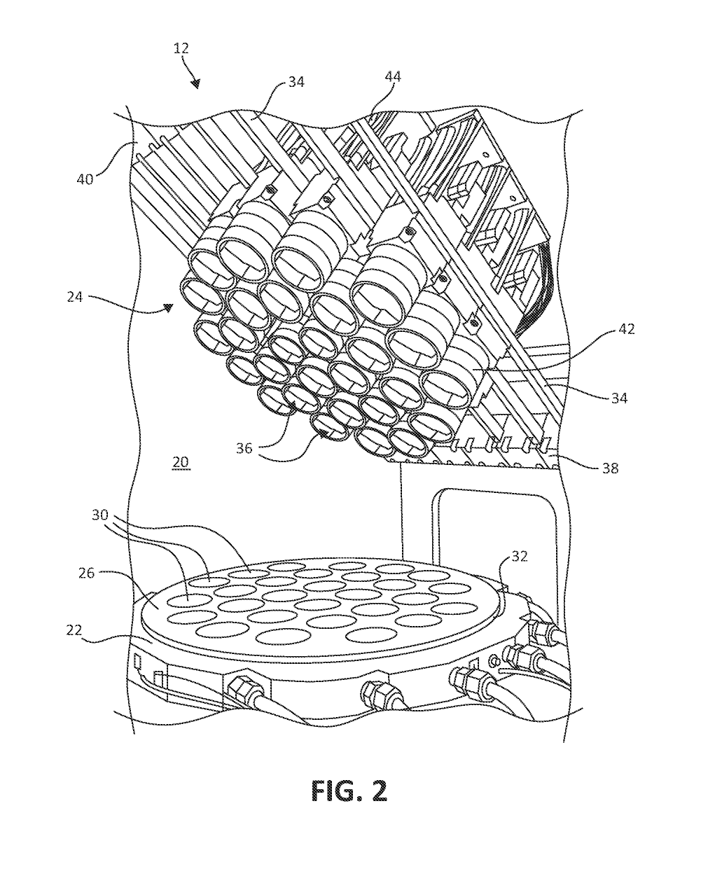

FIGS. 1 and 2 illustrate a substrate processing tool (or system) 10, according to one embodiment of the present invention. The substrate processing tool 10 is a “wet” processing tool, as is commonly understood, and includes a wet processing apparatus 12, a processing fluid supply (or supply system) 14, and a control system 16. As will be described in greater detail below, the substrate processing tool 10 shown in FIGS. 1 and 2 may be used to perform processing steps on distinct, isolated regions of a substrate, as opposed to the “interstitial” regions between the isolated regions.

The wet processing tool 12 includes a housing 18 enclosing (or defining) a processing chamber 20, a substrate support 22, and a wet processing assembly 24. The substrate support 22 is positioned within the processing chamber 20 and is configured to hold a substrate 26.

Although not shown in detail, the substrate support 22 may be configured to secure the substrate using, for example, a vacuum chuck, electrostatic chuck, or other known mechanism. Further, although not shown, the substrate support 22 may be coupled to the housing 18 via an actuator (e.g., a pneumatic cylinder) configured to vertically move the substrate support 22, such as for positioning the substrate 26.

Referring specifically to FIG. 2, the substrate 26 includes a series of isolation (or first) regions 30 on the upper surface thereof and an outer edge 32. As is evident in FIG. 2, the regions 30 have widths (or diameters) that are considerably smaller than a width (or diameter) of the substrate 26. As described below, each of the regions 30 may be processed by one of multiple isolation units within the wet processing assembly 24. The portion(s) of the substrate 26 outside of the isolation regions 30 may be referred to as an “interstitial” (or second) region (or portion) of the upper surface of the substrate 26.

The substrate 26 may be a conventional, round substrate (or wafer) having a diameter of, for example, 200 millimeter (mm) or 300 mm. In other embodiments, the substrate 26 may have other shapes, such as a square or rectangular. It should be understood that the substrate 26 may be a blanket substrate (i.e., having a substantial uniform surface), a coupon (e.g., partial wafer), or even a patterned substrate having predefined regions (e.g., regions 30). The isolation regions 30 may have any convenient shape, e.g., circular, rectangular, elliptical, wedge-shaped, etc. In the semiconductor field a region may be, for example, a test structure, single die, multiple die, portion of a die, other defined portion of a substrate, or a undefined area of a substrate, e.g., blanket substrate, which is defined through the processing.

Referring again to both FIGS. 1 and 2, the wet processing assembly 24 includes a scaffolding 34 and an array of isolation (or wet processing) units 36 attached to the scaffolding 34. The scaffolding 34 extends between end pieces 38 and 40. As shown in FIG. 2, end piece 38 is pivotably (or rotatably) coupled to the housing 18.

As shown in FIG. 2, the isolation units 36 are arranged in a series of rows, with each of the isolation units 36 corresponding to one of the regions 30 on the substrate 26. However, it should be understood that the number and arrangement of the isolation units 36 may differ, as is appropriate given the size and shape of the substrate 26 and the arrangement of the regions 30. Each of the isolation units 36 includes a body (or container or reactor) 42.

In some embodiments, the isolation units 36 may also include a transducer actuator housed above the body 42, and a transducer (i.e., megasonic transducer) positioned within the body 42 and coupled to the transducer actuator. Further, the isolation units 36 may be configured in a variety of ways to provide common mechanisms used in wet processing, such as stiffing and/or mechanical agitation, brush cleans, polishing, and electroplating.

Each of the isolation units 36 (and/or the body 42 thereof) is in fluid communication with the processing fluid supply system 14 via a series of fluid lines 44. Further, each of the isolation units 36 is in operable communication with the control system 16 via wiring 46.

The processing fluid supply system 14 includes one or more supplies of various processing fluids, both liquids and gases, as well as temperature control units to regulate the temperatures of the various fluids. Additionally, the processing supply system 14 includes one or more fluid pumps (e.g., liquid pumps and gas pumps) for delivering the fluids to the isolation units 36 and/or providing vacuum supplies to the isolation units 36, as well as a series of valves interconnecting the various supplies and the isolation units 36. The control system 16 includes, for example, a processor and memory (i.e., a computing system) in operable communication with the processing fluid supply system 14 and the isolation units 36 and is configured to control the operation thereof as described below.

Referring again to FIGS. 1 and 2, the substrate 26 is positioned on the substrate support 22 (e.g., by a robot which is not shown) when the substrate support 22 is in a lowered position. The substrate support 22 is then raised such that the bodies 42 of the isolation units 36 are horizontally aligned above the substrate 26 (or the upper surface thereof). More specifically, each of the isolation units 36 is positioned over, and spaced apart from (i.e., the bodies 42 do not contact the substrate 26), a respective one of the isolation regions 30 on the substrate 26.

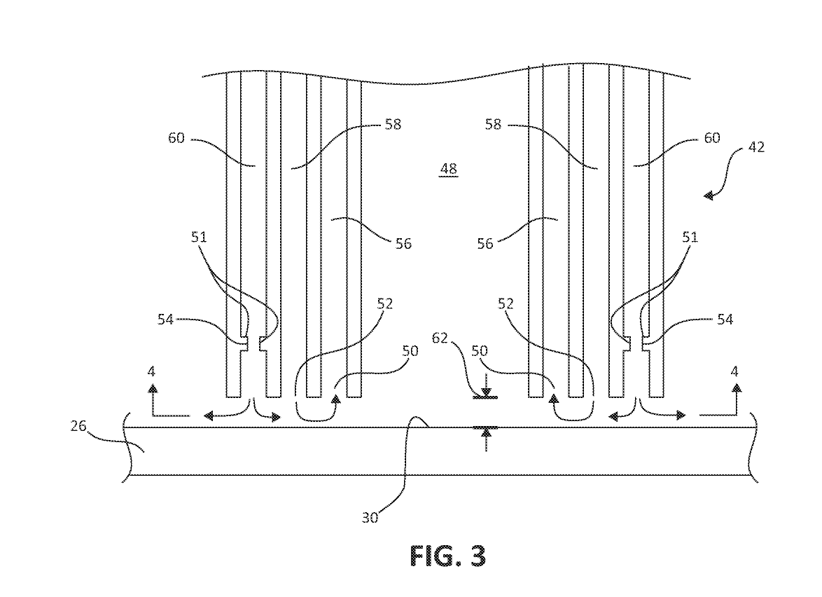

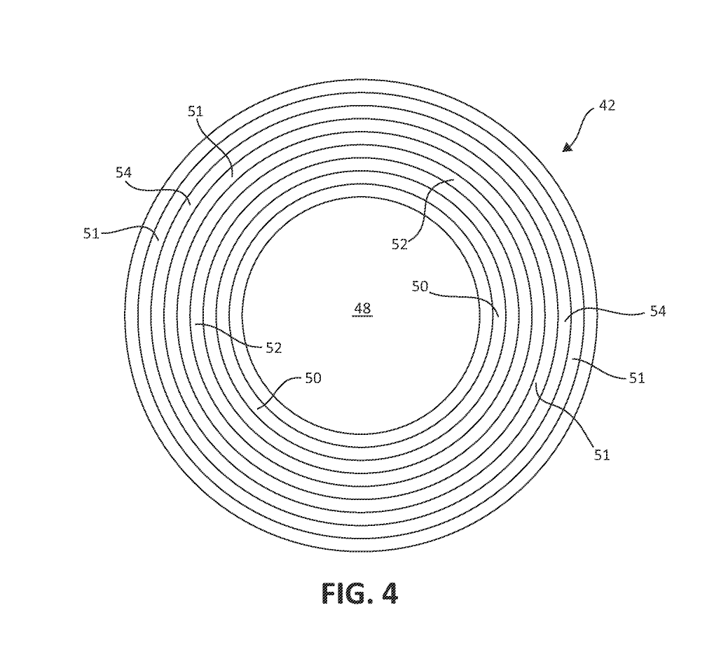

FIGS. 3 and 4 illustrate the body 42 of one of the isolation units 36, as positioned above a respective region 30 on the substrate 26, in greater detail. As shown, the body 42 is substantially cylindrical in shape and includes a central receptacle 48 and an annular trench outlets 50, 52, and 54 extending into a lower surface thereof. In the embodiment shown, the central receptacle 48, like the body 42 itself, is substantially cylindrical in shape and positioned at a central portion of the body 42.

Although not specifically illustrated, the central receptacle 48 is in fluid communication with the processing fluid supply 14 (e.g., via fluid lines 44 shown in FIG. 1). The trench outlets 50, 52, and 54 symmetrically surround the central receptacle 48 with trench outlet being positioned between trench outlet 50 and trench outlet 54. As shown, trench outlet 50 is formed between annular protrusions 51 within the body 42. The trench outlets 50, 52, and 54 are respectively in fluid communication with annular plenums 56, 58, and 60 that are in fluid communication with the processing fluid supply 14. Each of the annular plenums 56, 58, and 60 may be in fluid communication with a different liquid or gas pump. Of particular interest is that the body 42 of the isolation unit 36 does not contact the upper surface of the substrate 26. In one embodiment, a distance 62 between the lowest portion of the body 42 and the substrate 26 is, for example, between 0.02 and 0.12 mm (but may be as small as a few micrometers). The body 42 may be made of a chemically inert material, such as polytetrafluoroethylene (PTFE) or any machinable plastic compatible with the chemistries and temperatures described herein.

In operation, after the wet processing assembly 24 (FIG. 1) is lowered, a wet process, as is commonly understood, is performed on the isolation region(s) 30 of the substrate 26. Examples of wet processes that may be performed on the substrate 26 include wet cleanings, wet etches and/or strips, and electroless depositions.

Referring again to FIG. 3, the operation of the wet processing apparatus 12 (FIG. 1) will now be described with respect to one of the isolation units 36. However, it should be understood that all of the isolation units 36 may be similarly operated at the same time.

In order to create a barrier around the region 30, a liquid (hereinafter referred to as a “barrier liquid”), such as one with a relatively high surface tension (e.g., deionized

(DI) water), is delivered to annular plenum 58 in the body 42 of each of the isolation units 36 by the processing fluid supply 14 (e.g., by a first liquid pump). The barrier liquid flows from the annular plenum 58 through annular trench outlet 52 and onto the substrate 26, where it flows both inwards towards the center of the respective region 30 on the upper surface of the substrate 26 and outwards, away from the region 30. In one embodiment, a liquid pump (e.g., a second liquid pump) in the processing fluid supply 14 simultaneously applies a vacuum to annular plenum 56 such that (at least some) of the barrier liquid is removed from the substrate 26 through annular trench outlet 50. This liquid flow (i.e., from annular trench outlet 52, inwards across the substrate 26, and into annular trench outlet 50) creates an annular liquid barrier around the respective isolation region 30 on the substrate 26 that prevents processing fluid (e.g., a liquid) on the substrate 26 from passing between the isolation region 30 and the interstitial portion of the substrate 26. It should be understood that this flow of liquid is, in at least one embodiment, maintained during the wet processing described below.

In another embodiment, rather than the constant flow described above, the liquid barrier may be formed with “static” volumes of the barrier liquid. For example, the barrier liquid may be dispensed from the annular plenum 58 through annular trench outlet 52 and onto the substrate 26, and the surface tension of the liquid may cause the liquid to be trapped between the body 42 and the substrate 26 sufficiently to form the barrier. The distance 62 between the substrate 26 and the body 42 may be adjusted to facilitate this. This static barrier may be allows to remain on the substrate 26 without any of the barrier liquid being removed until after the processing has been completed, as described below.

At the same time the liquid barrier(s) is formed, a processing (or barrier) gas, such as nitrogen or argon, is delivered to annular plenum 60 by the processing fluid supply 14 (e.g., a gas pump). The gas is driven through annular trench outlet 54 onto the upper surface of the substrate 26, where it flows both towards and away from the isolation region 30. This flow of gas creates an annular gas barrier around the respective isolation region 30, as well as the respective liquid barrier, to further prevent any fluid on the substrate 26 (both the processing fluid and the barrier liquid) from passing between the isolation region 30 and the interstitial portion of the substrate 26.

Still referring to FIG. 3, a processing fluid (e.g., a liquid), such as a cleaning solution, is then delivered to the central receptacle 48 of the body 42 from the processing fluid supply 14 (FIG. 1), while the liquid and gas flow described above is occurring. The liquid flows onto the respective isolation region 30 on the substrate 26, where it is restricted from flowing onto the interstitial portion of the substrate 26 by the liquid barrier (and the gas barrier). As such, as the processing liquid continues to flow into the central receptacle 48, a column of liquid is formed within the isolation unit 36 over the respective isolation region 30 of the substrate 26.

After a predetermined amount of time (i.e., depending on the particular wet process being performed), the processing liquid may be removed from the central receptacle 48 by the processing fluid supply 14 (i.e., a vacuum supply). As such, embodiments of the present invention allow for wet processes to be performed on only particular portions of the substrate 26, without any of the components of the tool 10 contacting the upper surface of the substrate 26. Thus, the likelihood that any contaminates will be left on the substrate 26 is reduced.

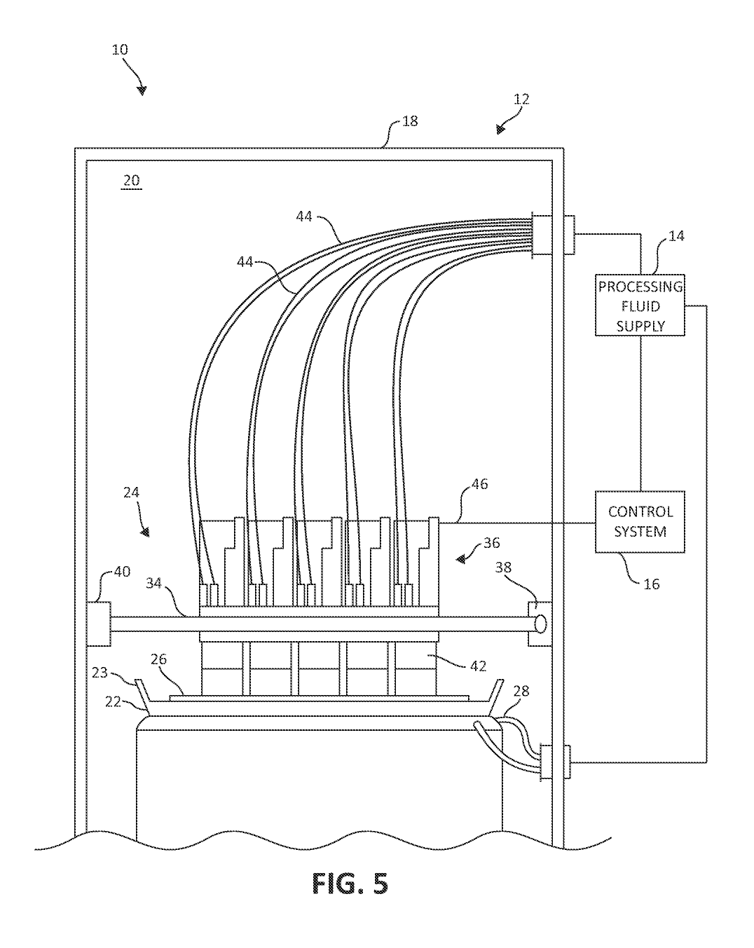

FIG. 5 illustrates a substrate processing tool (or system) 10, according to another embodiment of the present invention. The embodiment shown in FIG. 5 may be used to process the “interstitial” portion of the substrate 26 (FIG. 2). As with the embodiment described above, the tool 10 includes a wet processing apparatus 12, a processing fluid supply (or supply system) 14, and a control system 16. Of particular interest in FIG. 5 is that the substrate support 22 includes a lip 23 extending upwards (i.e., to a height greater than a thickness of the substrate 26) around a periphery thereof. The lip 23 extends around the entire substrate support such that a interstitial container or tub is formed, the use of which is described in greater detail below. Additionally, the substrate support 22 may have a series of fluid passageways extending therethrough (and connected to the interstitial container) which are in fluid communication with the processing fluid supply system 14 via support fluid lines 28.

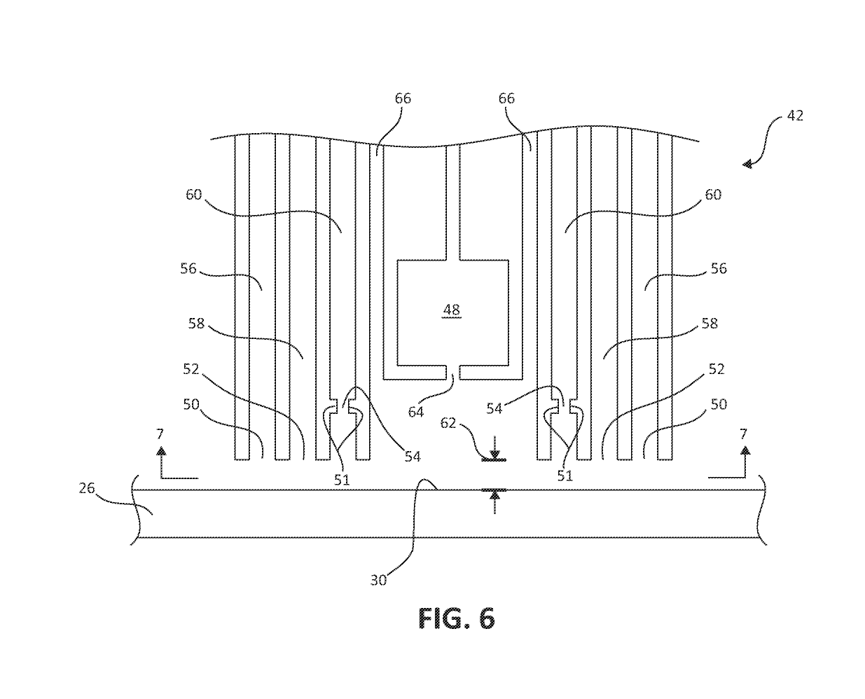

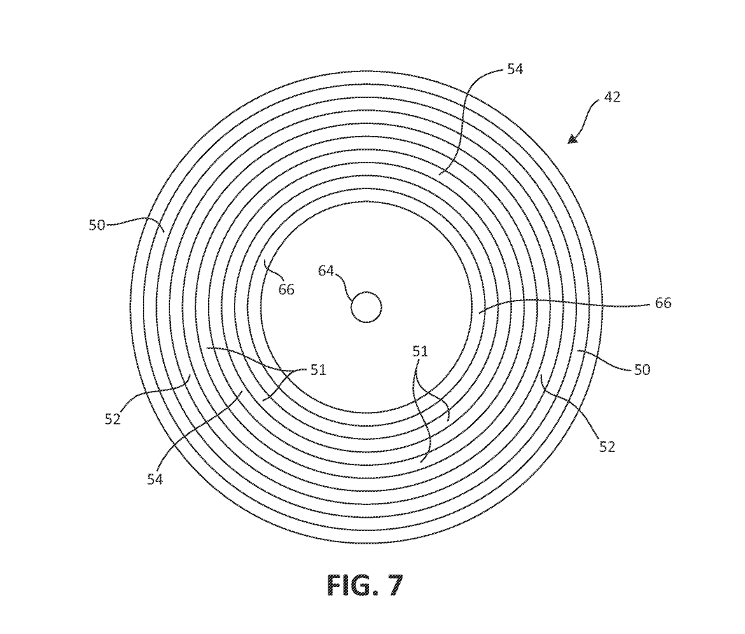

FIGS. 6 and 7 illustrate the body 42 of one of the isolation units 36 in the tool 10 shown in FIG. 5, according to one embodiment of the present invention. Similar to the embodiment shown in FIGS. 3 and 4, the body 42 shown in FIGS. 6 and 7 includes annular trench outlets 50, 52, and 54, and the associated annular plenums 56, 58, and 60, along with the central receptacle 48. However, the arrangement of the annular trench outlets 50, 52, 54 (as well as the annular plenums 56, 58, and 60) has been changed such that annular trench outlet 54 is closest to the central receptacle 48 and annular trench outlet 50 is farthest from the central receptacle 48. Also, the size of the central receptacle 48, which is in fluid communication with the processing fluid supply 14, has been reduced to form a central plenum, with a central outlet 64 extending into the lower surface of the body 42. Further, the body 42 includes a vent 66, which in depicted embodiment is in the form of another annular trench, which is also in fluid communication with the processing fluid supply 14 (FIG. 1).

Still referring to FIGS. 6 and 7, the operation of the wet processing apparatus 12 in FIG. 5 will now be described with respect to one of the isolation units 36. However, it should be understood that all of the isolation units 36 may be similarly operated at the same time.

Similar to the embodiment shown in FIGS. 3 and 4, a barrier liquid, such as deionized (DI) water, is delivered to annular plenum 58 in the body 42 of each of the isolation units 36 by the processing fluid supply 14. The barrier liquid flows from the annular plenum 58 through annular trench outlet 52 and onto the substrate 26, where it flows both inwards towards the center of the respective isolation region 30 on the upper surface of the substrate 26 and outwards, away from the region 30. In a “constant flow” embodiment, a liquid pump in the processing fluid supply 14 simultaneously applies a vacuum to annular plenum 56 such that (at least some) of the barrier liquid is removed from the substrate 26 through annular trench outlet 50. This liquid flow (i.e., from annular trench outlet 52, outwards across the substrate 26, and into annular trench outlet 50) creates an annular liquid barrier around the respective isolation region 30 on the substrate 26 that prevents processing fluid (e.g., a liquid) on the substrate 26 from passing between the isolation region 30 and the interstitial portion of the substrate 26. It should be understood that this flow of liquid is, in at least one embodiment, maintained during the wet processing described below.

At the same time the liquid barrier(s) is formed, a processing (or barrier) gas, such as nitrogen or argon, is delivered to annular plenum 60 and the central receptacle 48 by the processing fluid supply 14, while the vent 66 is “vented” (i.e., connected to a vent at atmospheric pressure).

The gas is driven through annular trench outlet 54 and the central outlet 64 onto the upper surface of the substrate 26, where it flows both towards and away from the isolation region 30. This flow of gas creates a gas barrier that surrounds the respective isolation region 30 and is surrounded by the respective liquid barrier to further prevent any fluid on the substrate 26 (both the processing fluid and the barrier liquid) from passing between the isolation region 30 and the interstitial portion of the substrate 26.

Referring again to FIG. 5, processing liquid is then delivered into the interstitial container formed by the lip 23 on the substrate support 22 by the processing fluid supply 14 such that the substrate 26 is submerged in the processing liquid. However, because of the liquid barrier (as well as the gas barrier) formed by each isolation unit 36, the processing liquid is restricted from flowing onto the isolation regions 30, and only covers the interstitial portion of the substrate 26. As a result, only the interstitial portion of the substrate 26 is processed. Additionally, if any of the processing liquid begins to flow near the periphery of the isolation regions 30, the processing liquid is pulled upwards into the annular trench outlet 50, along with the barrier liquid.

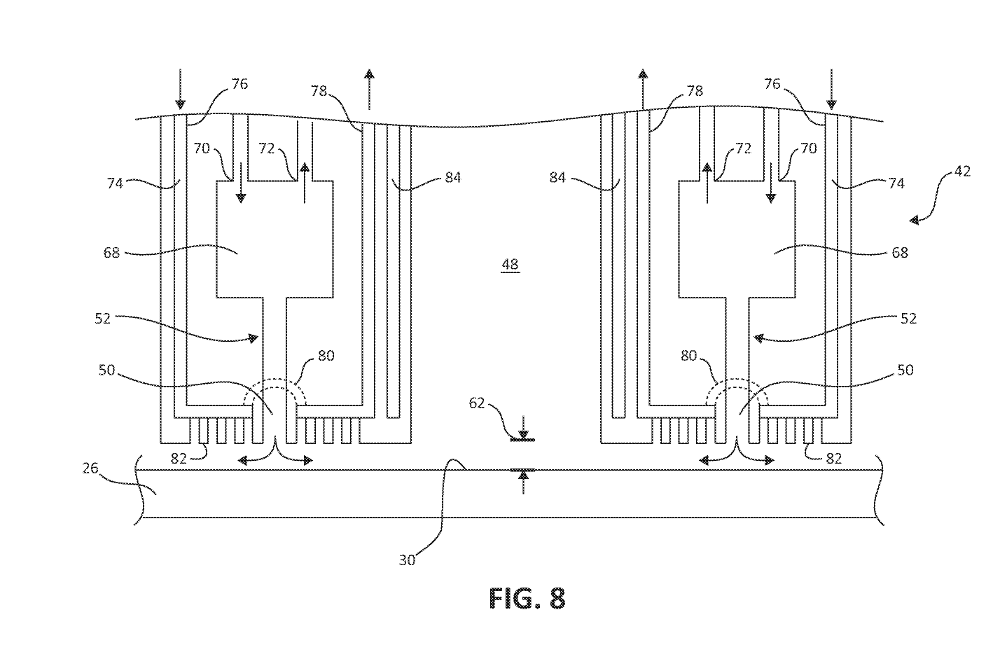

FIG. 8 illustrates the body 42 of one of the isolation units 36 in the tool 10, according to one embodiment of the present invention. As shown in FIG. 8, the body 42 may be used in the substrate processing tool 12 shown in FIG. 1. The body 42 may be similar in shape to those shown in FIGS. 3 and 6, and likewise include a central receptacle 48.

However, in the embodiment shown in FIG. 8, only one annular trench outlet 50, along with a single annular plenum 52, is included. The annular plenum 52 is shaped to have one or more liquid reservoirs 68 formed therein, which have inlet ports 70 and outlet ports 72 in fluid communication with the processing fluid supply 14.

Also unlike the previous embodiments, the body 42 shown in FIG. 8 includes one or more fluid conduits 74, each of which include an inlet 76 and an outlet 78 (in fluid communication with the processing fluid supply 14). As shown, a lower portion of the fluid conduit 74 extends into the lower portion of the body 42, near the lower surface thereof, and includes bridge portions 80 that extend through the annular trench outlet 50 and/or the annular plenum 52. Additionally, a series of heat exchange fins 82 are formed on the lower surface of the body 42 and/or into the lower portion of the body 42 on both sides of the annular trench outlet 50. Further, the body 42 includes a thermal break plenum 84, which may be an annular-shaped cavity vertically arranged near the central receptacle 48.

In operation, the wet processing assembly 24 (FIG. 1) is positioned above the substrate 26 as indicated in FIG. 8. A barrier liquid, such as deionized water, is delivered into the liquid reservoir 68 through the inlet port 70 and flows through the annular trench outlet 50 onto the substrate 26.

A temperature-controlled fluid (e.g., a coolant), is flown through the fluid conduit and heat is exchanged between the barrier liquid and the temperature-controlled fluid through the heat exchange fins. In this manner, the substrate processing tool 12 includes a liquid barrier temperature control system. By controlling the temperature of the barrier liquid, the surface tension of the barrier liquid may be controlled. As is commonly understood, the surface tension of the barrier liquid generally increases as its temperature decreases, and vice versa, as dictated by

γV^{2/3}=k(T_{c}−T), (1)

where V is the molar volume, T_{c} is the critical temperature, and k is the Eötvös Constant.

Additionally, the distance 62 between the body 42 and the substrate 26 may be controlled by, for example, raising and lowering the substrate support 22 (FIG. 1). This may be useful depending on the desired temperature of the barrier liquid (i.e., higher temperature barrier liquids will have less surface tension.

As such, by adjusting the temperature of the barrier liquid and the distance 62, the surface tension of the barrier liquid may cause the barrier liquid to be “trapped” between the lower surface of the body 42 and the substrate 26, and thus form a liquid barrier around the respective isolation portion 30 of the substrate 26. It should be noted that in the embodiment shown in FIG. 8, the liquid barrier may be formed using stationary barrier liquid, which is removed through the outlet port(s) 72 of the reservoirs 68 after the wet processing has taken place. It should also be noted that such an embodiment may also be used for performing wet processes on the interstitial portion of the substrate 26. However, in such an embodiment, it may be desirable to have a thermal break plenum 84 on a side of the annular plenum 52 opposite the central receptacle.

The embodiments described herein provide details for a multi-region processing system and associated processing heads that enable processing a substrate in a combinatorial fashion. Exemplary details of combinatorial processing techniques are provided in U.S. Pat. No. 7,544,574, filed on Feb. 10, 2006, and claiming priority from Oct. 11, 2005, U.S. Pat. No. 7,824,935, filed on Jul. 2, 2008, U.S. Pat. No. 7,871,928, filed on May 4, 2009, and claiming priority from Oct. 15, 2005, U.S. Pat. No. 7,902,063, filed on Feb. 10, 2006, and claiming priority from Oct. 15, 2005, and U.S. Pat. No. 7,947,531 filed on Aug. 28, 2009, all of which are assigned to Intermolecular, Inc. (San Jose, Calif.) and incorporated by reference herein. Exemplary details of combinatorial processing techniques are further provided in U.S. patent application Ser. No. 11/352,077, filed on Feb. 10, 2006, and claiming priority from Oct. 15, 2005, U.S. patent application Ser. No. 11/419,174, filed on May 18, 2006, and claiming priority from Oct. 15, 2005, U.S. patent application Ser. No. 11/674,132, filed on Feb. 12, 2007, and claiming priority from Oct. 15, 2005, and U.S. patent application Ser. No. 11/674,137, filed on Feb. 12, 2007, and claiming priority from Oct. 15, 2005, all of which are also assigned to Intermolecular, Inc. (San Jose, Calif.) and are incorporated by reference herein.

As such, according to one aspect of the present invention, the substrate processing tool 10 also is provided with a variation generating system (or subsystem) configured to intentionally vary (or create differences between) the wet processes performed on two or more of the regions 30 and/or the interstitial portion of the substrate 26. The variation generating system may include, for example, the processing fluid supply system 14, the transducers (in embodiments having transducers), and/or the control system 16.

It should be understood that the size, shape, and number of the isolation units 36 and/or the corresponding regions 30 on the substrate 26 may be different in other embodiments. For example, the substrate 26 may include four isolation regions, each substantially covering a “quadrant” of the upper surface, and the isolation units 36 (and/or the bodies 42 thereof) may be appropriately sized and shaped to match.

Thus, in one embodiment, a substrate processing tool is provided. The substrate processing tool includes a housing defining a chamber. A substrate support is coupled to the housing and configured to support a substrate within the chamber. The substrate has an upper surface with a first portion and a second portion surrounding the first portion. An isolation unit including a body is coupled to the housing and positioned within the chamber above the first portion of the upper surface of the substrate. The body includes at least one outlet on a lower surface thereof. At least one liquid pump is in fluid communication with the array of outlets. The at least one outlet is configured to drive liquid through the at least one outlet onto the upper surface of the substrate to form a liquid barrier around the first portion of the upper surface of the substrate.

In another embodiment, a method for processing a substrate is provided. An isolation unit including a body is positioned above and spaced apart from an isolation portion of the upper surface of a substrate. The upper surface of the substrate further includes an interstitial portion surrounding the isolation portion. The body includes at least one outlet on a lower surface thereof. Liquid is caused to be driven through the at least one outlet such that a liquid barrier is formed around the isolation portion of the upper surface of the substrate.

In a further embodiment, a substrate processing tool is provided. The substrate processing tool includes a housing defining a chamber. A substrate support is coupled to the housing and configured to support a substrate within the chamber. The substrate has an upper surface with a plurality of isolation portions and an interstitial portion surrounding each of the isolation portions. A plurality of isolation units including a body are coupled to the housing. Each is positioned within the chamber above a respective one of the plurality of isolation portions of the upper surface of the substrate. The body of each of the plurality of isolation units includes first and second annular outlets on a lower surface thereof extending around the periphery of the respective one of the plurality of isolation portions of the upper surface of the substrate. At least one liquid pump is in fluid communication with the first and second annular outlets of the body of each of the plurality of isolation units. The at least one liquid pump is configured to drive liquid through the first annular outlet of the body of each of the plurality of isolation units onto the substrate to form a liquid barrier around each of the plurality of isolation portions of the upper surface of the substrate and remove the liquid from the substrate through the second annular outlet of the body of each of the plurality of isolation units.

Although the foregoing examples have been described in some detail for purposes of clarity of understanding, the invention is not limited to the details provided. There are many alternative ways of implementing the invention. The disclosed examples are illustrative and not restrictive.

What is claimed:

1. A substrate processing tool comprising:
a housing defining a chamber;
a substrate support coupled to the housing and configured to support a substrate within the chamber, the substrate having an upper surface with a first portion and a second portion surrounding the first portion;
an isolation unit comprising a body coupled to the housing and positioned within the chamber above the first portion of the upper surface of the substrate, the body comprising at least one outlet on a lower surface thereof; and
at least one liquid pump in fluid communication with the array of outlets and configured to drive liquid through the at least one outlet onto the upper surface to form a liquid barrier around the first portion of the upper surface of the substrate.

2. The substrate processing tool of claim 1, wherein the at least one liquid pump comprises a first liquid pump in fluid communication with the at least one outlet of the body of the isolation unit and a second liquid pump in fluid communication with the at least one outlet of the body of the isolation unit.

3. The substrate processing tool of claim 2, wherein the first liquid pump is configured to deliver the liquid through the at least one outlet of the body of the isolation unit onto the upper surface of the substrate, and the second liquid pump is configured to remove the liquid from the upper surface of the substrate through the at least one outlet of the body of the isolation unit.

4. The substrate processing tool of claim 3, further comprising a liquid barrier temperature control system configured to adjust a temperature of a portion of the body of the isolation unit, said adjusting of the temperature of the portion of the body of the isolation unit causing heat to be exchanged between the portion of the body of the isolation unit and the liquid on the upper surface of the substrate.

5. The substrate processing tool of claim 2, wherein the at least one outlet comprises a first annular trench substantially extending around a periphery of the first portion of the upper surface of the substrate and a second annular trench surrounding the first annular trench.

6. The substrate processing tool of claim 5, wherein the first liquid pump is in fluid communication with the first annular trench, and the second liquid pump is in fluid communication with the second annular trench.

7. The substrate processing tool of claim 6, wherein the at least one outlet further comprises a third annular trench, and further comprising a gas pump in fluid communication with the third annular trench such that when gas is driven through the third annular trench by the gas pump, a gas barrier is formed around the first portion of the upper surface of the substrate, the gas barrier preventing the fluid on the upper surface of the substrate from flowing between the first portion of the upper surface of the substrate and the second portion of the upper surface of the substrate.

8. The substrate processing tool of claim 7, wherein the body of the isolation unit further comprises a central receptacle extending into the lower surface thereof.

9. The substrate processing tool of claim 8, wherein the first annular trench, the second annular trench, and the third annular trench surround the central receptacle, and the third annular trench surrounds the first annular trench and the second annular trench.

10. The substrate processing tool of claim 8, wherein the first annular trench, the second annular trench, and the third annular trench surround the central receptacle, and the first annular trench and the second annular trench surround the third annular trench.

11. A method for processing a substrate comprising:
positioning an isolation unit comprising a body above and spaced apart from an isolation portion of the upper surface of a substrate, the upper surface of the substrate further comprising an interstitial portion surrounding the isolation portion, the body comprising at least one outlet on a lower surface thereof; and
causing liquid to be driven through the at least one outlet such that a liquid barrier is formed around the isolation portion of the upper surface of the substrate.

12. The method of claim 11, wherein the upper surface of the substrate further comprises a plurality of isolation portions, each of the isolation portions being surrounded by the interstitial portion of the upper surface of the substrate, and further comprising:
positioning an isolation unit comprising a body above and spaced apart from each of the plurality of isolation portions of the upper surface of the substrate, the body of each isolation unit comprising at least one outlet on a lower surface thereof; and
causing liquid to be driven through the at least one outlet of each isolation unit such that a liquid barrier is formed around each isolation portion of the upper surface of the substrate.

13. The method of claim 11, wherein the at least one outlet comprises a first annular trench substantially extending around a periphery of the isolation portion of the upper surface of the substrate and a second annular trench surrounding the first annular trench.

14. The method of claim 13, wherein the causing of the liquid to be driven through the at least one outlet comprises:
delivering the liquid through the first annular trench onto the upper surface of the substrate; and
removing the liquid from the upper surface of the substrate through the second annular trench.

15. The method of claim 14, wherein the at least one outlet further comprises a third annular trench extending around a periphery of the isolation portion of the upper surface of the substrate, and further comprising causing gas to be driven through the third annular trench such that a gas barrier is formed around the isolation portion of the upper surface of the substrate.

16. A substrate processing tool comprising:
a housing defining a chamber;
a substrate support coupled to the housing and configured to support a substrate within the chamber, the substrate having an upper surface with a plurality of isolation portions and an interstitial portion surrounding each of the isolation portions;
a plurality of isolation units comprising a body coupled to the housing, each being positioned within the chamber above a respective one of the plurality of isolation portions of the upper surface of the substrate, the body of each of the plurality of isolation units comprising first and second annular outlets on a lower surface thereof extending around the periphery of the respective one of the plurality of isolation portions of the upper surface of the substrate; and
at least one liquid pump in fluid communication with the first and second annular outlets of the body of each of the plurality of isolation units, wherein the at least one liquid pump is configured to drive liquid through the first annular outlet of the body of each of the plurality of isolation units onto the substrate to form a liquid barrier around each of the plurality of isolation portions of the upper surface of the substrate and remove the liquid from the substrate through the second annular outlet of the body of each of the plurality of isolation units.

17. The substrate processing tool of claim 16, wherein the body of each of the plurality of isolation units further comprises a third annular outlet on the lower surface thereof extending around the periphery of the respective one of the plurality of isolation portions of the upper surface of the substrate, and further comprising a gas pump in fluid communication with the third annular outlet of the body of each of the plurality of isolation units such that when gas is driven through the third annular outlet by the gas pump, a gas barrier is formed around each of the plurality of isolation portions of the upper surface of the substrate.

18. The substrate processing tool of claim 16, further comprising an interstitial container coupled to the housing and configured to hold liquid on the interstitial portion of the upper surface of the substrate.

19. The substrate processing tool of claim 16, wherein the body of each of the plurality of the isolation units further comprises a central receptacle extending into the lower surface thereof, and wherein the first and second annular outlets surrounds the central receptacle.

20. The substrate processing tool of claim 19, further comprising a processing liquid supply in fluid communication with the central receptacle of each body of the plurality of isolation units.
